(19) United States
(12) Patent Application Publication
(10) Pub. No.: US 2009/0078217 A1
(43) Pub. Date: Mar. 26, 2009

(54) Hydraulic system for operating the gate on a chute for immobilizing animals

(76) Inventor: William S. Riley, Lubbock, TX (US)

Correspondence Address: DRUDE FAULCONER, 1321 COMANCHE DRIVE, RICHARDSON, TX, 75080, US

(21) Appl. No.: 12/012,407

(22) Filed: Feb. 1, 2008

Related U.S. Application Data
(60) Provisional application No. 60/994,796, filed on Sep. 21, 2007.

(51) Int. Cl. A01K 1/06; A61D 3/00; A01K 15/00

(52) U.S. Cl. 119/723; 119/752

(57) ABSTRACT

A hydraulic system for operating the front gate of a chute for immobilizing an animal where the gate can be unlatched/opened or closed/latched in a single operation. The system is comprised of a gate cylinder for opening and closing the gate and a latch cylinder for unlatching and latching the gate wherein the cylinders are interconnected by respective short and longer lengths of hose whereby hydraulic fluid will reach and actuate one of the cylinders (i.e. unlatches the gate or closes the gate) before it flows to and actuates the other cylinder (e.g. opens the gate or latches the gate).

### CROSS-REFERENCE TO EARLIER FILED APPLICATION

The present application claims the priority of U.S. Provisional Application No. 60/994,796, filed Sep. 21, 2007.

### 1. TECHNICAL FIELD

The present invention relates to an automated apparatus for immobilizing an animal and in one of its aspects relates to a chute for immobilizing an animal while trimming the hoofs of the animal wherein the exit or front gate can be unlatched/latched and opened/closed in a single operation by a single operator from a single operating position.

### 2. BACKGROUND OF THE INVENTION

It has long been a routine procedure to trim the horn-growth (toenail-like material) on the hoofs of certain animals. For example, modern dairy cattle are normally very large animals that spend long periods of time standing on hard surfaces (e.g. concrete floors of dairy barns). If the horn-like growth of these cattle becomes too long, the cattle are likely to experience severe discomfort which, in turn, can seriously affect their milk production. Accordingly, most dairymen have the hoofs of their dairy cattle trimmed by a professional operator at routine, scheduled intervals.

For this venture to be profitable for the trimmer and yet affordable by the dairymen, it is necessary for the trimmer to be able process a large number of cattle in a relatively short period of time. To make this possible, each cow has to be restrained or immobilized so that the trimmer can access and trim each of the hoofs of the cow in the quickest possible time with minimum risk to his own safety.

Special structures (sometimes called “chutes”) have now been developed in which an animal (hereinafter collectively referred to as a “cow”) is held while its hoofs are trimmed. Such structures may be stationary, i.e. affixed to a concrete slab or the like at a hoof-trimming station such as a dairy farm, or may be portable, i.e. mounted on a vehicle to be moved from station to station by an operator (e.g. a professional hoof trimmer). In the use of such chutes, a cow is herded through a rear gate into the chute and up against the normally closed and latched front gate of the chute. The rear gate is then closed by an operator to confine the animal within the chute and the head of the cow extends through an opening in the front gate and is immobilized by a stanchion or the like which is movably mounted in the front gate.

This allows the chute, with the cow secured therein, to be rotated about its longitudinal axis to lay the cow onto its side thereby lifting all four hoofs of the cow off the ground and exposing them for trimming by the hoof trimmer. After the hoofs are trimmed, the chute is rotated back to its original position to put the cow back onto its feet and the front gate is unlatched and opened so that the cow can exit the chute through the front of the chute. The front gate is then closed and latched and the rear gate is then opened again and the procedure is repeated with the next cow.

One important consideration in hoof-trimming, especially with commercial hoof-trimmers, is the time and effort required for loading, immobilizing, and unloading each individual cow during the hoof-trimming operation. In some prior art chutes, two operators were used to operate the rear and front gates during the loading and unloading of each cow to speed up the operation. If only one operator was used, he/she had to move back and forth between the rear and front of the chute during each trimming operation. As will be appreciated by those familiar with this industry, any added time required to load and unload a cow can accumulate substantially over a day's operation thereby significantly reducing the number of cows which can be processed which, in turn, adversely affecting the profit for the trimmer and the expense for the cows' owner.

More recently, a structure for trimming hoofs and the like has been developed which has addressed the above mentioned concerns; see U.S. Pat. No. 5,669,332, issued to W. S. Riley, on Sep. 23, 1997, and which is incorporated herein, in its entirety, by reference. In such chutes, a single operator can quickly load, immobilize, and then release a cow from the chute from a single station at the rear of the chute.

While this chute has proved highly successful and has readily been adopted within the industry, a rather sophisticated system of pulleys and rods is used for unlatching the front gate of the chute before it is opened at the end of a trimming operation. That is, a mechanical linkage system is used whereby the operator physically steps on a foot pedal at the rear of the chute to release the latch which secures the front gate in its closed and locked position. In addition to the added cost and maintenance of this manual system, the step of unlatching the front gate must be manually carried out independently of the opening of the gate, itself. Therefore, there is always the possibility that an operator may actuate the gate-opening, hydraulic cylinder before he manually unlatches the gate which, in turn, can substantially slow up the trimming operation and add to the maintenance of the chute. Therefore, it should be recognized that it is extremely desirable to eliminate any such potential problems from the trimming operation.

### SUMMARY OF THE INVENTION

The present invention provides a chute for immobilizing an animal (e.g. cow) having a highly simplified and fool-proof front gate operating system for closing/latching and unlatching/opening the front gate of the chute.

Basically, the front gate operating system comprises a first or latch power cylinder which rotates a latch element between a latched (i.e. engagement with a latch bar fixed on the front gate) and an unlatched position (i.e. out of engagement with the fixed bar on the front gate) The latch cylinder is fluidly connected into a power fluid (e.g. hydraulic fluid) supply system and is interconnected with a second or gate power cylinder which, in turn, opens and closes the front gate. When a valve is moved to a first position, fluid flows through a transmission line into a first Tee connector on the latch cylinder. Since the fluid reaches the latch cylinder first, the fluid flows through one leg of the Tee and into the latch cylinder to move the piston in the cylinder thereby rotating the latch bar to its unlatched position thereby unlatching the front gate.

When the piston in the latch cylinder dead ends in its cylinder, all of the fluid in the transmission line then is forced through and the other leg of the first Tee and flows to the gate cylinder to move the piston in the gate cylinder to its open position thereby opening the front gate. The lengths of the connecting, fluid transmission lines or hoses are such that the fluid is supplied to actuate the two respective cylinders in the proper sequence both to unlatch and open the front gate in a single operation. That is, the fluid reaches and actuates the latch cylinder to unlatch the front gate before it then automatically flows to the gate cylinder to open the gate.

Once the cow has exited the chute through the now open front gate, the valve is moved to a second position which now allows the power fluid to flow first through a first leg of a second Tee connector on the gate cylinder to move the gate cylinder to its closed position to thereby close the gate. Once the gate cylinder dead ends and the gate is closed, the fluid then flows through a second leg of the second Tee connector and through a transmission line to the latch cylinder to rotate the latch element in the opposite direction to thereby engage the bar on front gate and latch the front gate in its closed position. The operation is then repeated with each cow. The entire unlatching/opening and the closing/latching operations are carried out by a single operator from a single location and are both quick and requires little manual effort on the part of the operator.

### BRIEF DESCRIPTION OF THE DRAWINGS

The actual construction operation, and apparent advantages of the present invention will be better understood by referring to the drawings, not necessarily to scale, in which like numerals identify like parts and in which:

FIG. 1 is a perspective view of the immobilizing chute of the present invention as it might be mounted on a vehicle;

FIG. 2 is a perspective view of the chute of FIG. 1 with the chute being rotated to a horizontal position;

FIG. 3 is a top view of the chute of FIG. 1;

FIG. 4 is a view of one side of the chute of FIG. 1 showing the gate cylinder for opening and closing the front gate;

FIG. 5 is a view of the other side of the chute of FIG. 1 showing the latch cylinder for rotating the latch bar to latch and unlatch the front gate;

FIG. 6 is front view of the chute of FIG. 1; and

FIG. 7 is a schematical view of the power fluid system of the present invention which operates the latch and gate cylinders of the chute of FIG. 1.

While the invention will be described in connection with its preferred embodiments, it will be understood that this invention is not limited thereto. On the contrary, the invention is intended to cover all alternatives, modifications, and equivalents that may be included within the spirit and scope of the invention, as defined by the appended claims.

### DESCRIPTION OF THE PREFERRED EMBODIMENTS

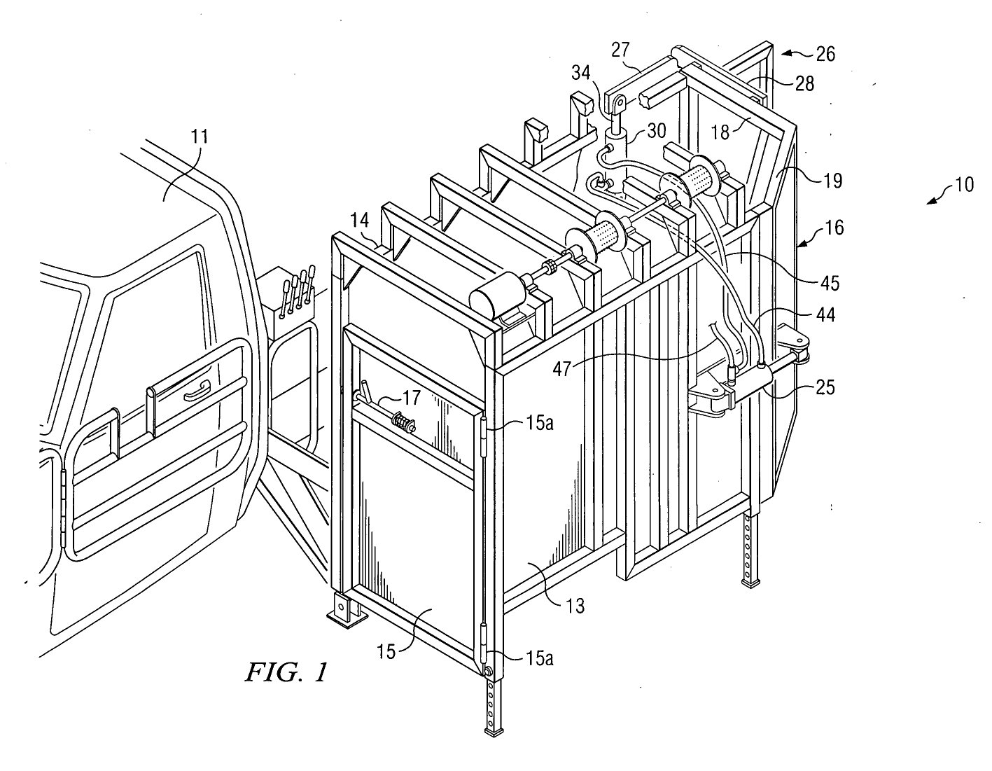

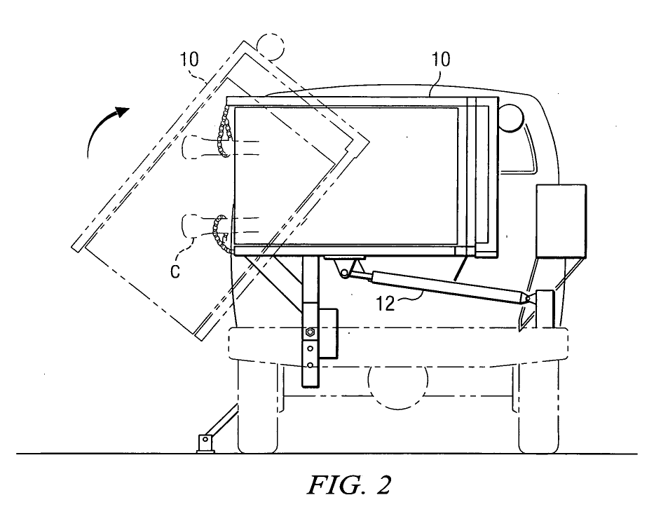

Referring more particularly to the drawings, FIG. 1 discloses the chute 10 of the present invention as it may be pivotably mounted onto a vehicle 11 which allows the chute to be easily transported between operational sites or stations. The chute may also be pivotably mounted on a fixed slab (not shown) or the like (not shown) when it is to be used at stationary site (i.e. a particular dairy farm or the like). As shown in FIG. 2, the solid lines show chute 10 in its horizontal or hoof-trimming position (also stored position during transport if mounted on vehicle 11) after the chute has been rotated by fluid-operated cylinder 12 from it normal vertical position (the dotted lines in FIG. 2 show the chute as it is being rotated). As will be understood, the lower legs of the cow(dotted lines L in FIG. 2) are secured with stubbing chains C or the like, before the chute is rotated. As used herein throughout, “power fluid” is intended to include preferred hydraulic fluids but may include compressible gases such as air, etc. and “fluid-operated cylinder” is meant to include cylinders which have a piston therein which is moved in either direction within the cylinder by the power fluid, as will be well understood in the art.

Basically, chute 10 is comprised of a three-dimensional, elongated, substantially rectangular framework as shown in the figures. As used herein, the terms “vertical”, horizontal”, “top”, ‘bottom”, front”, ‘rear”, etc. will refer to chute 10 when it is in its upright, vertical position (e.g. FIG. 1). While the precise construction details and the actual materials used in constructing chute 10 may vary, its basic construction will remain substantially the same.

More specifically, a typical chute 10 is basically a frame comprised of side walls 13, 14, and a front gate 16 and a rear gate 15. The various components may be comprised of lengths of any appropriate material (e.g. square steel conduit) which are connected by any appropriate means, e.g. welding. For a complete description for a typical construction of chute 10, see U.S. Pat. No. 5,669,332, issued to W. S. Riley, on Sep. 23, 1997, which is incorporated herein, in its entirety, by reference.

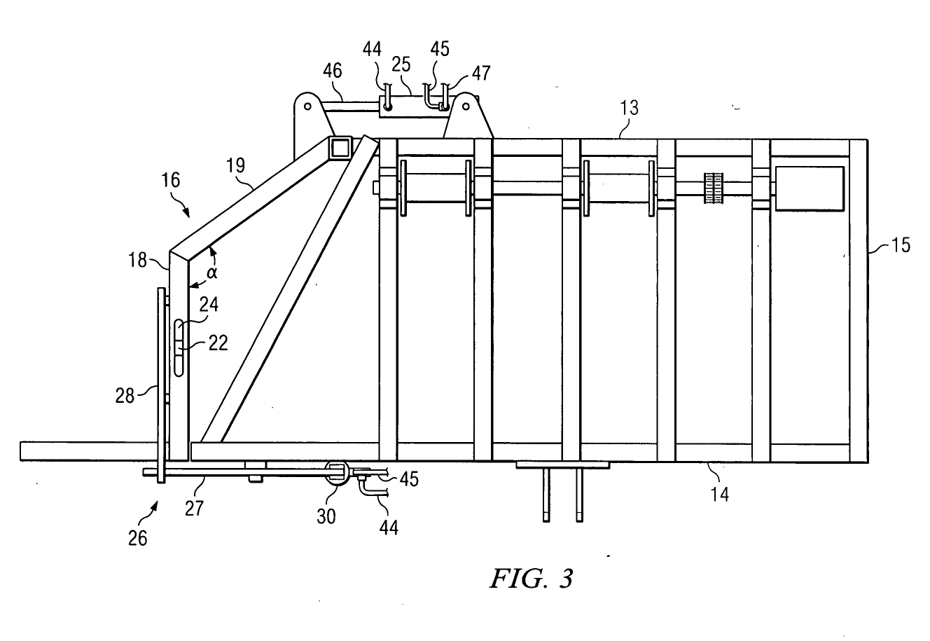

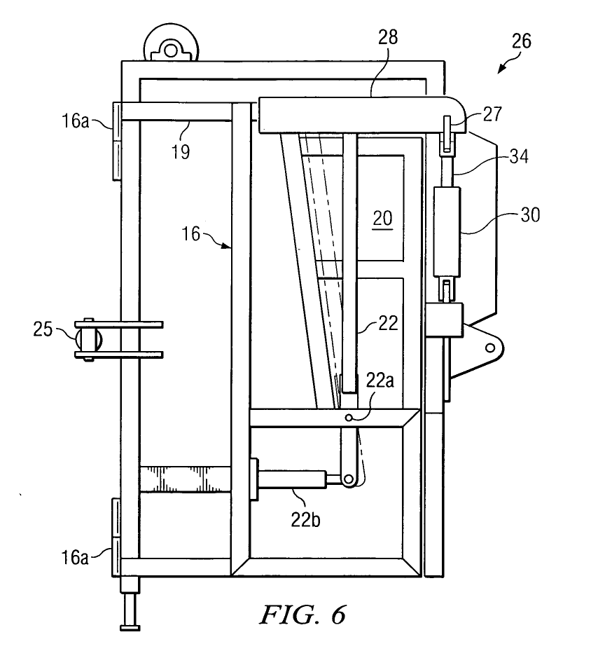

A rear gate 15 is hinged at 15a at the rear of the chute 10 and is releasably, secured in its closed position by a manually operated, spring-biased latch 17. Front gate 16 is hinged at 16a (FIG. 6) and is moved between its open and closed positions by fluid-operated cylinder unit 25. Preferably, front gate 16 is comprised of two vertical sections 18, 19 which are connected together at an obtuse angle a whereby section 52 provides an inwardly tapered surface (FIG. 3) when front gate 16 is in a closed position.

As a cow is herded into chute 10, tapered section 18 of front gate 16 will inherently direct or guide the cow's head into opening 20 (FIG. 6) of the gate. The cow's head and neck will now extend out of the chute 10 through opening 20 when the movable stanchion 22 is in its open position (dotted lines in FIG. 6). As shown, stanchion 22 has one end pivoted at 22a to a horizontal support on the front gate 16 and its other end extending through slot 24 (FIG. 3) in top support of section 19 of the front gate. The length of slot 24 limits the travel of stanchion 22 thereby preventing any harm to the cow when the stanchion is moved to its closed position against the neck of the cow to immobilize the movement of the head of the cow within the chute. Stanchion 22 is moved between its open and closed positions by fluid-operated cylinder 22b. The fluid in cylinder 22b also provides the latching function for stanchion 23 when the stanchion is in its closed position.

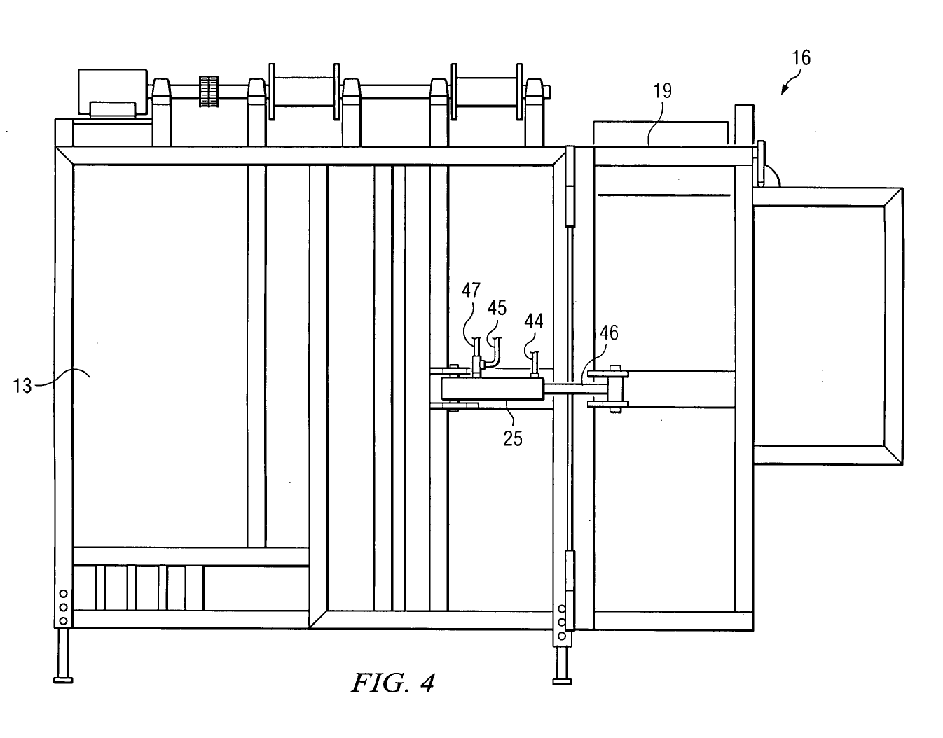

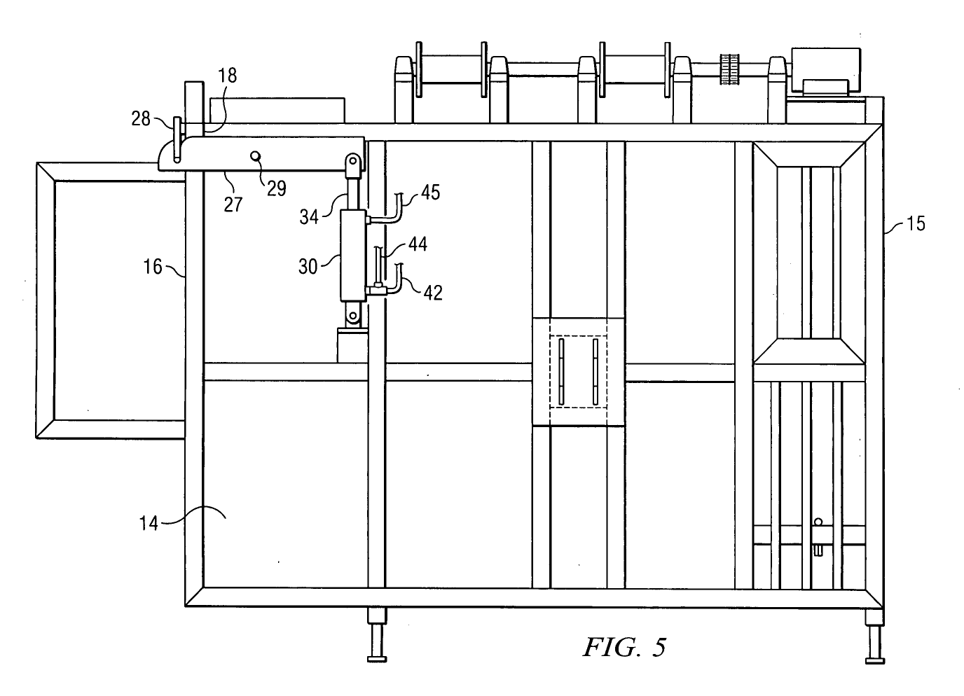

Front gate 16 is opened and closed by gate cylinder 25 which is mounted on side 13 of the chute (see FIGS. 1, 3, and 4). Front gate is held in a locked position by latching unit 26 (see FIGS. 1, 5, and 6). Latching unit 26 is comprised of a latch element 27 which is rotatably mounted about pivot 29 on the side 14 of the chute and a latch bar 28 which is secured to the top of gate 16. A fluid-operated, latch cylinder 30 rotates the latch 27 between a latched and unlatched position.

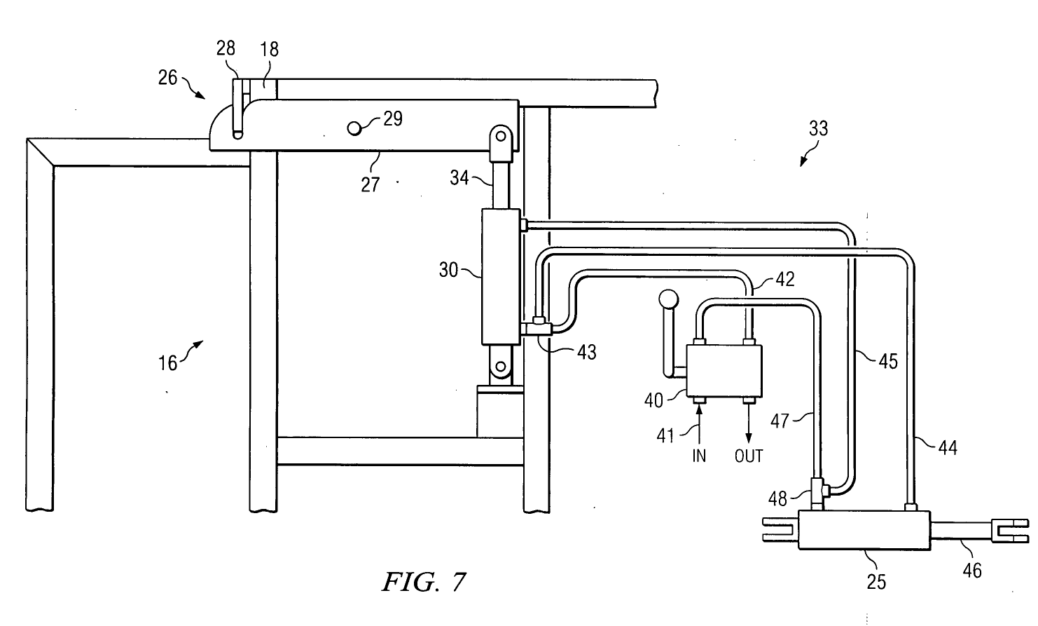

As best seen in FIG. 7, the gate cylinder 25 and the latch cylinder 30 are interconnected within a power fluid (e.g. hydraulic) supply system 33. In operation, to unlatch and open gate 16 in a single automatic operation, a valve 40 is moved to a first position to direct fluid from a source (e.g. fluid inlet 41 line) into a relative short length of line 42 (hydraulic hose) of a first set of fluid transport lines where the fluid exits into the inlet a first Tee connection 43 on latch cylinder 30. The fluid flows through the inlet and through one leg of Tee 43 into cylinder 30 to move piston rod 34 upward which, in turn, rotates latch element 27 to thereby disengage latch element 27 from the latch bar 28 which is secured across the top of gate 16. When the piston dead ends within the latch cylinder 30, the fluid in line 42 now flows through the inlet of the Tee and out the other leg of the first Tee 43 and through a relatively longer length of fluid transport line 44 to gate cylinder 25 to retract piston rod 46 in gate cylinder 25 to open gate 16.

To sequentially close and latch front gate 16 in its closed position in a single operation, the valve 40 is moved to a second position which now directs the flow of power fluid from inlet 41 through a relatively short line 47 of a second set of fluid transport lines to the inlet of a second Tee connection 48 on the opposite end of gate cylinder 25. The fluid flows through the inlet of the Tee and exits first through a first leg of second Tee 48 which is fluidly connected to gate cylinder 25 to move the piston rod 46 in the opposite direction to close the gate. When the piston dead ends in gate cylinder 25, the power fluid now flows through the other leg of the second Tee into a relatively longer length of fluid transport line 45 from which it flows into the opposite end of latch cylinder 30, thereby moving piston rod 34 downward to rotate latch 27 back up into engagement with bar 28 to securely latch the front gate 16 in a latched or locked position.

The precise timing of the flow of power fluid reaching a respective cylinder as required to sequentially unlatch/open or close/latch the gate in a single operation is controlled by interconnecting the cylinders with the appropriate, predetermined short and longer lengths of respective fluid transport lines (e.g. hydraulic hoses) so that fluid will arrive at and fully actuate one cylinder before it flows the other cylinder. This allows a single movement of valve 40 in one direction to result in sequentially unlatching and opening front gate 16 in single operation without any other effort on the part of the operator. Likewise, a single movement of valve 40 in another direction, both closes and latches gate 16 in its locked position. This reduces the physical effort and strain on an operator which can be substantial over a day's operation and increases his/her safety in loading and unloading a cow into chute 10. Also, the maintenance on the opening and latching mechanisms may be substantially reduced and the quick operation can save valuable time for each operation that can add up over a day's time.

Again, for a complete description of the basic construction of chute 10 and undescribed elements and the basic operation carried out in loading, trimming, and exiting of a cow, for the sake of brevity, please see U.S. Pat. No. 5,669,332, issued to W. S. Riley, on Sep. 23, 1997, which again is incorporated herein, in its entirety, by reference.

What is claimed is:

1. A chute for immobilizing an animal comprising:
a frame having two side walls and a rear gate,
a front gate pivotably mounted on said frame and moveable between an open position and a closed position;
a valve having a first position and a second position for controlling flow of power fluid from a source;
a fluid-operated, gate cylinder for moving said front gate between its said open and closed position;
a latch unit having a first position wherein said front gate is latched in said closed position and a second position wherein said front gate is unlatched and free to open;
a fluid-operated cylinder for moving said latch unit between its said first and second positions; and
a first set of fluid transport lines for fluidly interconnecting said latch cylinder and said gate cylinder together so that power fluid will first flow from said valve when in a first position to said latch cylinder to unlatch said gate and then automatically flow to said gate cylinder to open said gate in a single operation; and
a second set of fluid transport lines for fluidly interconnecting said cylinders together so that power fluid will first flow from said valve when in a second position to said gate cylinder to close said gate and then automatically flow to said latch cylinder to latch said gate in a closed position in a single operation.

2. The chute of claim 1 wherein said latch unit comprises:
a latch bar affixed to said front gate;
a latch element having a first end and a second end pivotably mounted on one of said two side walls; said first end of said latch element connected to said latch cylinder and said second end of said latch element adapted to engage said latch bar when said latch unit is in said latched position.

3. The chute of claim 2 wherein said first set of fluid transport lines comprises:
a first Tee connector having an inlet and two legs, one of said two legs being connected into said latch cylinder;
a relatively short length of fluid transport line fluidly connecting said valve to said inlet of first Tee connector; and
a relatively longer length of fluid transport line fluidly connecting the other of said legs of said first Tee connector to said gate cylinder.

4. The chute of claim 3 wherein said second set of fluid transport lines comprises:
a second Tee connector having an inlet and two legs, one of said two legs being connected into said gate cylinder;
a relatively short length of fluid transport line fluidly connecting said valve to said inlet of second Tee connector; and
a relatively longer length of fluid transport line fluidly connecting the other of said legs of said second Tee connector to said gate cylinder.

5. The chute of claim 4 wherein said power fluid comprises:
hydraulic fluid;
and wherein said fluid transport line comprises:
hydraulic hose.

6. In a chute for immobilizing an animal wherein said chute has a front gate, a system for automatically sequentially unlatching and opening said gate in single operation, said system comprising:
a valve having a first position and a second position for controlling flow of power fluid from a source;
a fluid-operated latch cylinder for unlatching and latching said gate;
a fluid-operated, gate cylinder for opening and closing said gate;
a first set of fluid transport lines for fluidly interconnecting said cylinders together so that power fluid will first flow from said valve when in a first position to said latch cylinder to unlatch said gate and then automatically flow to said gate cylinder to open said gate in a single operation.

7. The chute of claim 6 including:
a second set of fluid transport lines for fluidly interconnecting said cylinders together so that power fluid will first flow from said valve when in a second position to said gate cylinder to close said gate and then automatically flow to said latch cylinder to latch said gate in a closed position in a single operation.

8. The chute of claim 6 wherein said first set of fluid transport lines comprises:
a first Tee connector having an inlet and two legs, one of said two legs being connected into said latch cylinder;
a relatively short length of fluid transport line fluidly connecting said valve to said inlet of first Tee connector; and
a relatively longer length of fluid transport line fluidly connecting the other of said legs of said first Tee connector to said gate cylinder.

9. The chute of claim 7 wherein said second set of fluid transport lines comprises:
a second Tee connector having an inlet and two legs, one of said two legs being connected into said gate cylinder;
a relatively short length of fluid transport line fluidly connecting said valve to said inlet of second Tee connector; and
a relatively longer length of fluid transport line fluidly connecting the other of said legs of said second Tee connector to said gate cylinder.

10. The chute of claim 9 wherein said power fluid comprises:
hydraulic fluid;
and wherein said fluid transport line comprises:
hydraulic hose.
